(19) United States
(12) Patent Application Publication
(10) Pub. No.: US 2006/0185587 A1
(43) Pub. Date: Aug. 24, 2006

(54) Methods and apparatus for reducing ink conglomerates during inkjet printing for flat panel display manufacturing

(75) Inventors: Quanyuan Shang, Saratoga, CA (US); Fan Cheung Sze, San Jose, CA (US); John M. White, Hayward, CA (US)

Correspondence Address: DUGAN & DUGAN, PC, 55 SOUTH BROADWAY, TARRYTOWN, NY, 10591, US

(73) Assignee: APPLIED MATERIALS, INC.

(21) Appl. No.: 11/061,122

(22) Filed: Feb. 18, 2005

(51) Int. Cl. B05C 11/00

(52) U.S. Cl. 118/608

(57) ABSTRACT

In a first aspect, an apparatus is provided for reducing an ink conglomerate during flat panel display manufacturing. The apparatus includes (1) an inkjet head adapted to dispense ink onto a substrate during inkjet printing; (2) an ink reservoir adapted to store ink for inkjet printing and supply the ink to the inkjet head; and (3) a conglomerate-reducing device adapted to break apart conglomerates in the ink before the ink reaches the inkjet head. Numerous other aspects are provided.

### FIELD OF THE INVENTION

The present invention relates generally to flat panel display manufacturing, and more particularly to methods and apparatus for reducing ink conglomerates during inkjet printing (e.g., of color filters) for flat panel display manufacturing.

### BACKGROUND

An apparatus for flat panel display manufacturing may include an inkjet head for depositing ink onto a substrate (e.g., inkjet printing). The inkjet head may be coupled to an ink reservoir from which the inkjet head receives the ink. The inks employed by the apparatus (e.g., inks for manufacturing a color filter for a flat panel display) may include pigment suspended in a solution. Over time, for example, while the ink is stored or shipped, the dispersion of pigment in the ink may become non-uniform. More specifically, the pigment in the ink may conglomerate and/or coagulate to form larger particles (e.g., conglomerates) in the ink.

Such particles may adversely affect performance of the apparatus during flat panel display manufacturing. For example, such particles may reduce color transparency and/or saturation, resulting in visual quality performance problems. In addition, such particles may increase ink viscosity which may affect jetting performance repeatability and/or clog jetting nozzles. Consequently, the apparatus for flat panel display manufacturing typically may include one or more particle filters between the ink reservoir and the inkjet head. For example, a supply line coupling the ink reservoir to the inkjet head may include one or more particle filters. Such filters may be adapted to prevent particles formed in the ink supply and larger than approximately 1 micrometer from being transmitted to the inkjet head. However, such filters may allow an ink conglomerate smaller than 1 micrometer to pass through and reach the inkjet head. Accordingly, the use of particle filters may temporally prevent nozzle clogging but may not prevent the loss of pigment and color transparency. Adjusting the filters to prevent such smaller particles (e.g., conglomerates) formed in the ink supply from being transmitted to the inkjet head without inhibiting the flow of ink from the ink reservoir to the inkjet head is difficult. Accordingly, improved methods and apparatus for reducing ink conglomerates during flat panel display manufacturing (e.g., in-situ) are desirable.

### SUMMARY OF THE INVENTION

In a first aspect of the invention, an apparatus is provided for reducing ink conglomerates during flat panel display manufacturing. The apparatus includes (1) an inkjet head adapted to dispense ink onto a substrate during inkjet printing; (2) an ink reservoir adapted to store ink for inkjet printing and supply the ink to the inkjet head; and (3) a conglomerate-reducing device adapted to break apart conglomerates in the ink before the ink reaches the inkjet head.

In a second aspect of the invention, a method is provided for reducing conglomerates in ink during flat panel display manufacturing. The method includes the steps of (1) transferring the ink from an ink reservoir to an inkjet head; and (2) breaking apart conglomerates in the ink before the ink reaches the inkjet head. Numerous other aspects are provided in accordance with these and other aspects of the invention.

Other features and aspects of the present invention will become more fully apparent from the following detailed description, the appended claims and the accompanying drawings.

### BRIEF DESCRIPTION OF THE DRAWINGS

FIG. 1A is a perspective drawing of an inkjet printer module in accordance with an embodiment of the present invention.

FIG. 1B is a block diagram of an apparatus for reducing an ink conglomerate during flat panel display manufacturing in accordance with an embodiment of the present invention.

FIG. 2 illustrates a method of reducing an ink conglomerate during flat panel display manufacturing in accordance with an embodiment of the present invention.

FIG. 3 is a block diagram of a first exemplary embodiment of the apparatus of FIG. 1B in accordance with an embodiment of the present invention.

FIG. 4 is a block diagram of a second exemplary embodiment of the apparatus of FIG. 1B in accordance with an embodiment of the present invention.

FIG. 5 is a block diagram of a third exemplary embodiment of the apparatus of FIG. 1B in accordance with an embodiment of the present invention.

FIG. 6 is a block diagram of a fourth exemplary embodiment of the apparatus of FIG. 1B in accordance with an embodiment of the present invention.

FIG. 7 is a block diagram of a fifth exemplary embodiment of the apparatus of FIG. 1B in accordance with an embodiment of the present invention.

FIG. 8 is a block diagram of a sixth exemplary embodiment of the apparatus of FIG. 1B in accordance with an embodiment of the present invention.

FIG. 9 is a block diagram of a seventh exemplary embodiment of the apparatus of FIG. 1B in accordance with an embodiment of the present invention.

FIG. 10 is a block diagram of an eighth exemplary embodiment of the apparatus of FIG. 1B in accordance with an embodiment of the present invention.

FIG. 11 is a block diagram of a ninth exemplary embodiment of the apparatus of FIG. 1B in accordance with an embodiment of the present invention.

FIG. 12 is a block diagram of a tenth exemplary embodiment of the apparatus of FIG. 1B in accordance with an embodiment of the present invention.

FIG. 13 is a block diagram of an eleventh exemplary embodiment of the apparatus of FIG. 1B in accordance with an embodiment of the present invention.

FIG. 14 is a block diagram of a twelfth exemplary embodiment of the apparatus of FIG. 1B in accordance with an embodiment of the present invention.

FIG. 15 is a block diagram of a thirteenth exemplary embodiment of the apparatus of FIG. 1B in accordance with an embodiment of the present invention.

FIG. 16 is a block diagram of a fourteenth exemplary embodiment of the apparatus of FIG. 1B in accordance with an embodiment of the present invention.

FIG. 17 is a block diagram of a fifteenth exemplary embodiment of the apparatus of FIG. 1B in accordance with an embodiment of the present invention.

FIG. 18 is a block diagram of a sixteenth exemplary embodiment of the apparatus of FIG. 1B in accordance with an embodiment of the present invention.

FIG. 19 is a block diagram of a seventeenth exemplary embodiment of the apparatus of FIG. 1B in accordance with an embodiment of the present invention.

### DETAILED DESCRIPTION

The present invention provides methods and apparatus for reducing a conglomerate of ink during flat panel display manufacturing. More specifically, the present methods and apparatus may break apart ink conglomerates present in an ink supply so that only particles which do not adversely affect flat panel display manufacturing are present in the ink supply. In this manner, the present methods and apparatus may avoid the adverse affects described above, thereby improving flat panel display manufacturing.

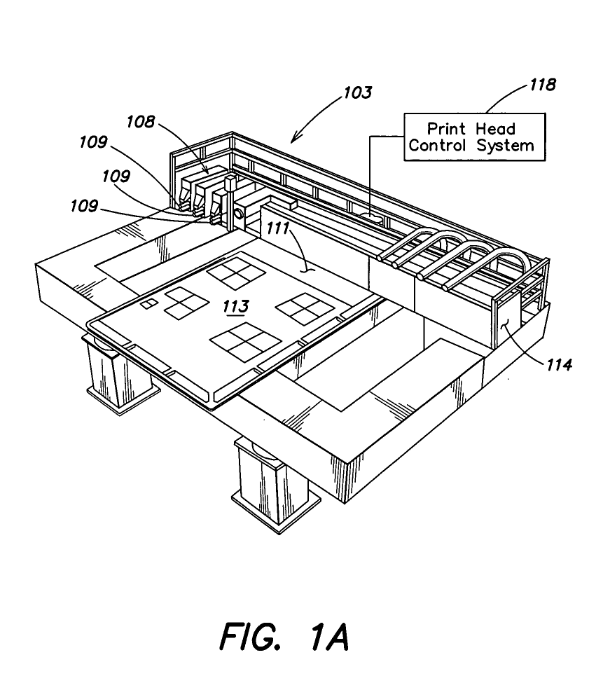

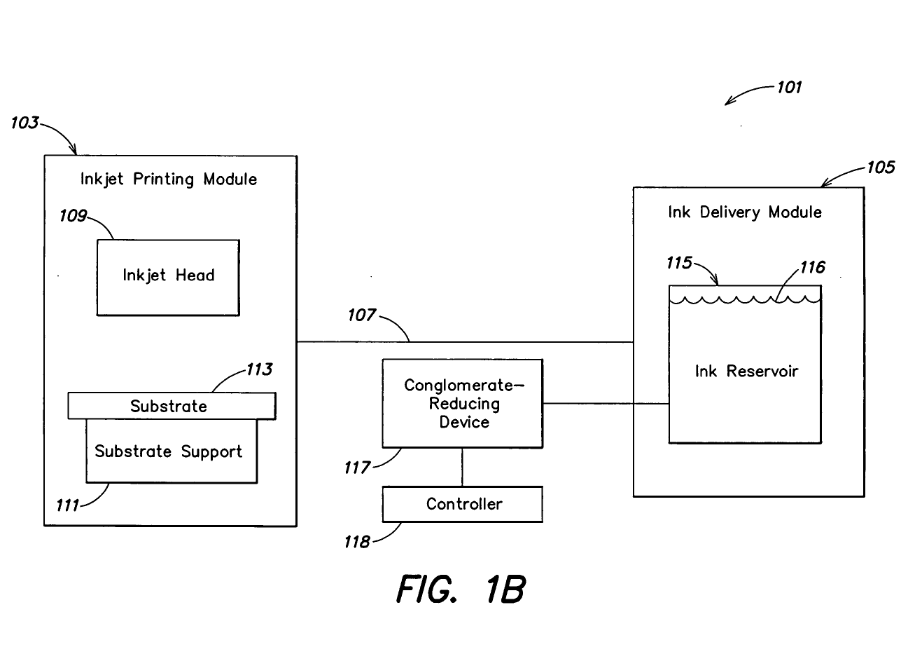

FIG. 1A is a perspective drawing of an inkjet printer module 103 suitable for use with embodiments of the present invention. One or more inkjet devices 108 may each include an inkjet head 109 for dispensing ink onto sub-pixels of a display object contained on a substrate 113 on a substrate support 111. The inkjet devices 108 may be suspended over and moved across the substrate 113 by an inkjet head support 114 while ink is dispensed under the direction of a controller 118 included as part of, or coupled to, the inkjet printer module 103.

FIG. 1B is a block diagram of an apparatus for reducing an ink conglomerate during flat panel display manufacturing in accordance with an embodiment of the present invention. With reference to FIG. 1B, the apparatus 101 for reducing an ink conglomerate during flat panel display manufacturing may include an inkjet printing module 103 coupled to an ink delivery module 105, for example, via an ink supply line 107. As indicated above, the inkjet printing module 103 may include any number of inkjet devices (not shown in FIG. 1B, but see FIG. 1A) each having an inkjet head 109 with at least one nozzle (not shown) for dispensing ink onto a sub-pixel of a display object or display objects contained on a substrate 113. In an exemplary embodiment, each inkjet head 109 has a plurality of nozzles. Although only one inkjet head 109 is shown in FIG. 1B, the inkjet printing module 103 may include a larger number of inkjet heads 109 as shown in FIG. 1A. Further, the inkjet printing module 103 may include a substrate support 111 for supporting a substrate 113 such that the inkjet head 109 may dispense ink onto one or more sub-pixels included in the substrate 113.

The ink delivery module 105 may include an ink reservoir 115 for storing ink 116 (e.g., ink for manufacturing a color filter for a flat panel display) and supplying such ink to an inkjet head 109 of the inkjet printing module 103 via the ink supply line 107. In one or more embodiments, the ink reservoir 115 may store about one to a few liters of ink (although the ink reservoir may store a larger or smaller volume of ink). Although only one ink reservoir 115 is shown, the apparatus 101 for reducing an ink conglomerate during flat panel display manufacturing may include a plurality of ink reservoirs 115 each of which may correspond to one or more respective inkjet heads 109 of the inkjet printing module 103. For example, the ink delivery module 105 may include a first inkjet reservoir for storing red ink and supplying such red ink to one or more inkjet heads 109 that dispense the red ink onto one or more sub-pixels of the substrate 113. Similarly, the ink delivery module 105 may include a second inkjet reservoir for storing green ink and supplying such green ink to one or more inkjet heads 109 that dispense the green ink onto one or more sub-pixels of the substrate 113 and a third inkjet reservoir for storing blue ink and supplying such blue ink to one or more inkjet heads 109 that dispense the blue ink onto one or more sub-pixels of the substrate 113. In some embodiments, the ink delivery module 105 may include more than one reservoir for storing ink of each color.

The apparatus 101 may include a respective conglomerate-reducing device 117 (only one shown) coupled to the one or more ink reservoirs 115 in the ink delivery module 105. The conglomerate-reducing device 117 may be adapted to reduce a conglomerate of ink in the ink supply before such conglomerate reaches the inkjet head 109. For example, the conglomerate-reducing device 117 may employ sonic energy or milling to reduce a conglomerate of ink in the ink supply before such conglomerate reaches the inkjet head 109. Although the conglomerate-reducing device 117 is shown external to the ink delivery module 103, in some embodiments, the ink delivery module 103 may include one or more portions of the conglomerate-reducing device 117. Further, although the ink reservoir 115 and conglomerate-reducing device 117 are shown as separate components, in some embodiments, the ink reservoir 115 may serve as one or more portions of the conglomerate-reducing device 117.

The conglomerate-reducing device 117, the ink delivery module 105, and (as indicated above) the inkjet printing module 103 may each be coupled to and operated under the control of the controller 118. In some embodiments, each of the components 103, 105, 117 may include a dedicated controller that is adapted to communicate with a central controller.

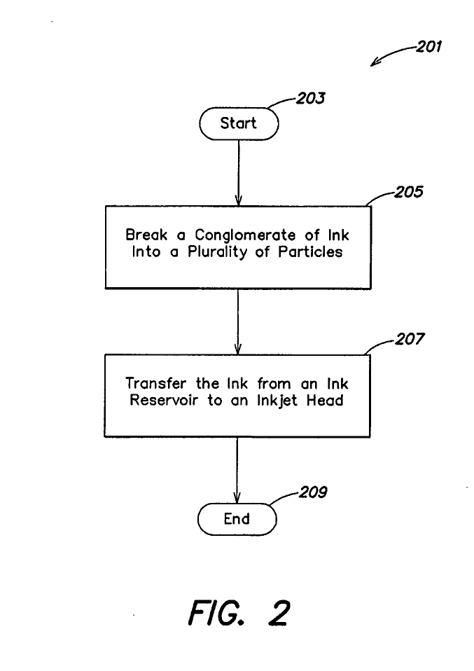

FIG. 2 illustrates a method of reducing an ink conglomerate during flat panel display manufacturing in accordance with an embodiment of the present invention. With reference to FIG. 2, in step 203, the method 201 begins. In step 205, a conglomerate of ink is broken into a plurality of “primary” particles (e.g., a primary pigment particle size or some other suitable size). For example, while the ink employed by the apparatus 101 is stagnant somewhere in the path through which the ink may be supplied to the inkjet head 109 (e.g., when the ink is stored in the ink reservoir 115) the ink may conglomerate and/or coagulate, thereby forming one or more conglomerates in the ink. The ink conglomerates may be of a size such that the conglomerates would clog the inkjet head 109 if the conglomerates reach the inkjet head 109. Alternatively or additionally, the conglomerates may degrade inkjet printing by causing light scattering on the substrate 113, reducing transparency of the substrate 113 and/or changing a color property of the ink. The larger particle size of a conglomerate may also reduce light absorbing power per unit weight of pigment. The conglomerate-reducing device 117 may break such conglomerates in the ink into smaller or primary particles of a size such that the particles may not cause the above-described problems. For example, the conglomerates may be broken into particles of the primary pigment particle size (e.g., approximately <0.1 micrometer). However, the conglomerate-reducing device 117 may break the conglomerates into particles of a larger or smaller size (e.g., during flat panel display manufacturing). Because ink viscosity tends to increase over time of ink storage, and such increased viscosity may affect inkjet drop size and quality, the conglomerate-reducing device 117 may employ a particle breaking device or technique, such as a sonication, milling or the like to restore the ink viscosity to or near its original value. In this manner, jetting repeatability may be improved.

Anywhere in the path through which the ink may be supplied to the inkjet head 109, the conglomerates of ink may be broken into particles which do not cause the problems described above. For example, the conglomerates of ink may be broken into such particles upstream from the ink reservoir 115, in the ink reservoir 115 and/or downstream from the ink reservoir 115.

In step 207, the ink may be transferred from the ink reservoir 115 to the inkjet printing head 109. Any conglomerates of ink may have been reduced and/or eliminated either upstream from the ink reservoir 115 or in the reservoir 115. Therefore, the ink transferred from the ink reservoir 115 to the inkjet head 109 may be free of or have reduced conglomerates. Alternatively or additionally, any conglomerates of ink may be reduced and/or eliminated downstream from the ink reservoir 115. In this manner, although the ink transferred from the ink reservoir 115 may include one or more conglomerates of ink, such conglomerates in the ink transferred from the ink reservoir 115 may be reduced and/or eliminated before reaching the inkjet head 109.

Additionally, because air bubbles may be created in the ink while breaking the ink conglomerates, a vacuum may be provided to (e.g., adjacent to) one or more locations in the path through which the ink may be supplied to the inkjet head 109, such that air bubbles in the ink are removed (e.g., reduced and/or eliminated). More specifically, if, in step 205, the conglomerate-reducing device 117 employs sonic energy to break a conglomerate of ink into a plurality of particles, cavitation caused by the sonic energy may create air bubbles in the ink. Alternatively, if, in step 205, the conglomerate-reducing device 117 employs milling to break a conglomerate of ink into a plurality of particles, the milling may create air bubbles in the ink. Therefore, a vacuum may be provided (1) adjacent the path through which the ink may be supplied to the inkjet head 109 upstream from the ink reservoir 115; (2) adjacent the ink reservoir 115; and/or (3) downstream from the ink reservoir 115. In this manner, adverse affects caused during flat panel display manufacturing by air bubbles in ink may be avoided. By combining a vacuum action with the conglomerate-reducing device 117, the ink can be degassed, which may positively improve jetting reliability.

Thereafter, step 209 may be performed. In step 209, the method 201 ends. Through use of the method 201 of FIG. 2, a conglomerate of ink may be broken into a plurality of particles such that the conglomerate of ink may not degrade inkjet printing by clogging the inkjet head 109, causing light scattering on the substrate 113, reducing transparency of the substrate 113 and/or changing a color property of the ink (e.g., during flat panel display manufacturing).

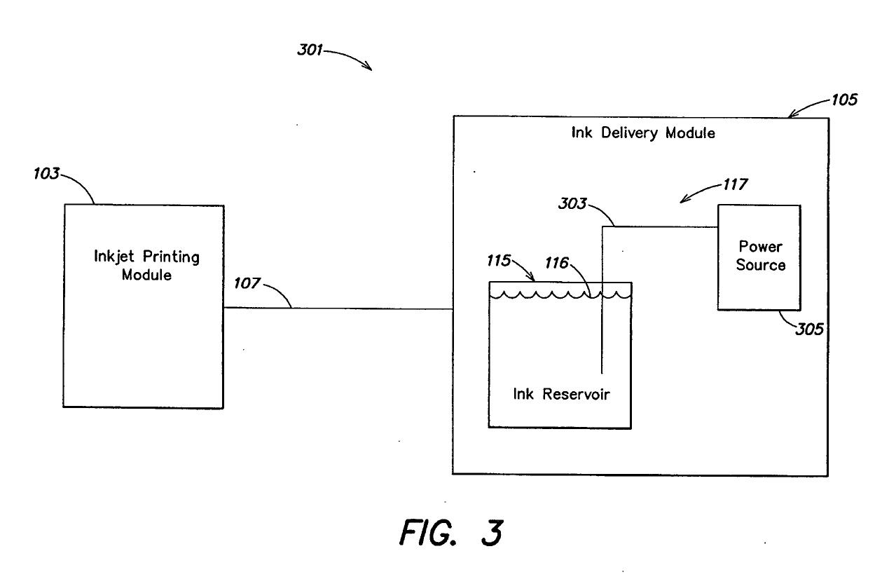

Exemplary embodiments of the apparatus 101 for reducing an ink conglomerate during flat panel display manufacturing are described below with reference to FIGS. 3-19. Some of the exemplary embodiments of the apparatus 101 employ sonic energy while others employ a milling process to reduce a conglomerate of ink during flat panel display manufacturing. Further, some of the exemplary embodiments of the apparatus 101 which employ sonic energy may include one or more sonic probes while other exemplary embodiments which employ sonic energy may include one or more transducers.

### Exemplary Embodiments Employing Sonic Energy

### Sonic Probes

FIG. 3 is a block diagram of a first exemplary embodiment of the apparatus of FIG. 1B in accordance with an embodiment of the present invention. With reference to FIG. 3, the conglomerate-reducing device 117 of the first exemplary embodiment 301 of the apparatus for reducing an ink conglomerate during flat panel display manufacturing includes a sonic probe 303 that may be coupled to a power source (e.g., a sonic power source) adapted to provide power to the sonic probe 303. For example, the conglomerate reducing device may be an EW-04711-60 750-Watt Ultrasonic Homogenizer manufactured by Cole-Parmer® of Vernon Hills, Ill., or the like. The sonic probe 303 may be adapted to receive power from the power source 305 and create sonic energy, such as ultrasonic, megasonic, or similar energy. Therefore, when the sonic probe 303 is inserted into ink stored in the ink reservoir 115, the sonic probe 303 may create such energy in the ink reservoir 115. The energy provided to the ink stored by the ink reservoir 115 may break a conglomerate of ink in such ink into a plurality of particles (e.g., particles which may not adversely affect flat panel display manufacturing). Although the ink delivery module 105 includes the conglomerate-reducing device 117, in some embodiments, one or more portions of the conglomerate-reducing device 117 (e.g., the power source 305) may be external to the ink delivery module 105. Further, although the conglomerate-reducing device 117 includes one probe 303 coupled to one power source 305, the conglomerate-reducing device 117 may include a larger number of probes 303 and/or power sources 305. Such additional probes 303 may be inserted into the ink reservoir 115 and/or one or more other components of the first exemplary embodiment 301 such that sonic energy created by the probes 303 in such components reduce and/or eliminate any conglomerates of ink in the ink of such components.

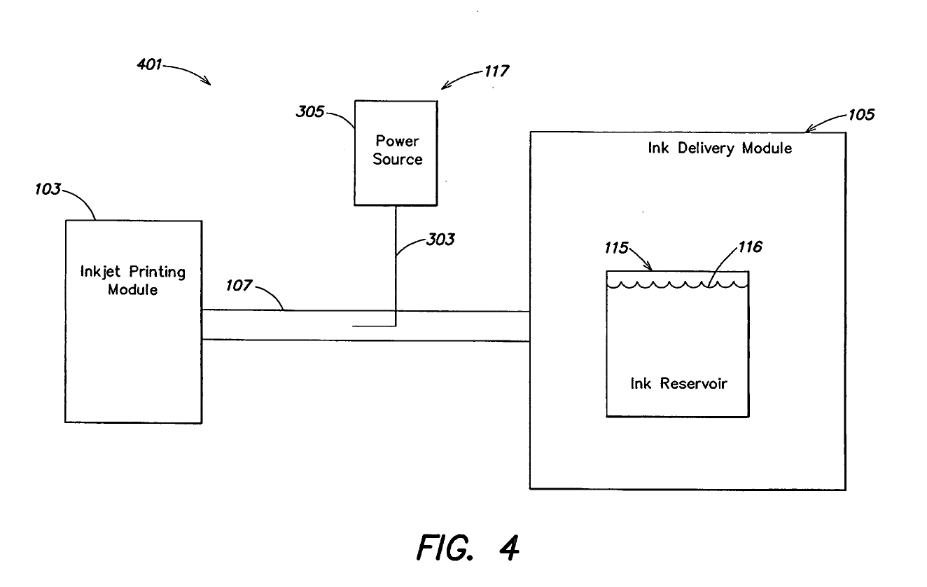

FIG. 4 is a block diagram of a second exemplary embodiment of the apparatus of FIG. 1B in accordance with an embodiment of the present invention. With reference to FIG. 4, similar to the third exemplary apparatus 301, the conglomerate-reducing device 117 of the second exemplary apparatus 401 for reducing an ink conglomerate during flat panel display manufacturing may include a sonic probe 303 that may be coupled to a power source 305 (e.g., a sonic power source) adapted to provide power to the sonic probe 303 such that the sonic probe 303 creates sonic energy. The sonic probe 303 of the second exemplary apparatus 401, however, may be inserted into the ink supply line 107, which couples the ink delivery module 105 to the inkjet printing module 103, and more specifically which couples the ink reservoir 115 to the inkjet head (not shown in FIG. 4; 109 in FIG. 1B). In this manner, the sonic energy created by the probe 303 may reduce and/or eliminate any conglomerates of ink transmitted from the ink delivery module 105 into the ink supply line 107. Although the conglomerate-reducing device 117 is external to the ink delivery module 105, in some embodiments, one or more portions of the conglomerate-reducing device 117 (e.g., the power source 305) may be included in the ink delivery module 105. Further, although the conglomerate-reducing device 117 includes one probe 303 coupled to one power source 305, the conglomerate-reducing device 117 may include a larger number of probes 303 and/or power sources 305. Such additional probes 303 may be inserted into the ink supply line 107 and/or one or more other components of the second exemplary embodiment 401 such that sonic energy created by the probes 303 in such components reduce and/or eliminate conglomerates of ink.

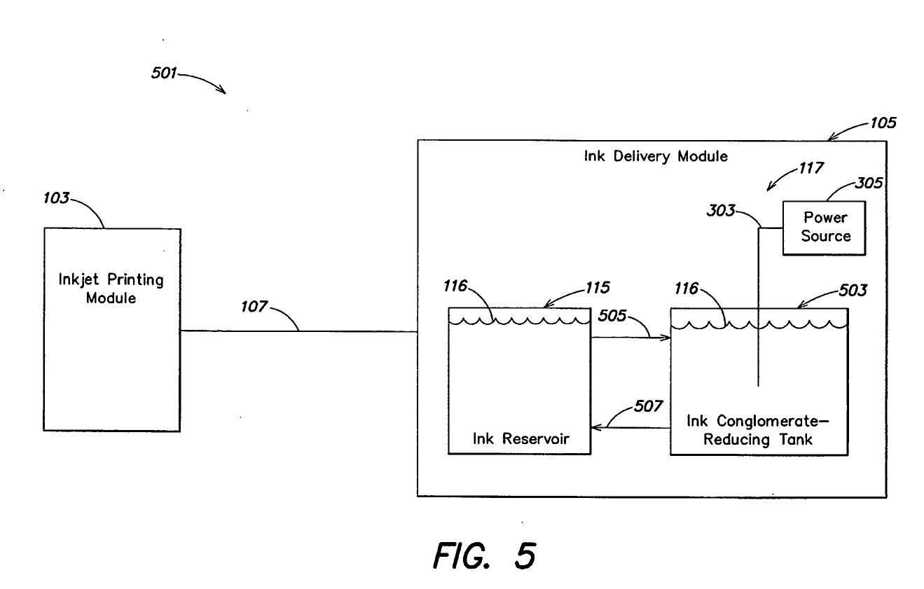

FIG. 5 is a block diagram of a third exemplary embodiment of the apparatus of FIG. 1B in accordance with an embodiment of the present invention. With reference to FIG. 5, the third exemplary embodiment 501 of the apparatus for reducing an ink conglomerate during flat panel display manufacturing may include an ink conglomerate-reducing tank 503 (for storing ink in which a conglomerate will be reduced) coupled to the ink reservoir 115. More specifically, the ink conglomerate-reducing tank 503 may be coupled the ink reservoir 115 via an ink circulation supply line 505 for transferring ink from the ink reservoir 115 to the ink conglomerate-reducing tank 503. Further, the ink conglomerate-reducing tank 503 may be coupled to the ink reservoir 115 via an ink circulation drain line 507 for transferring ink from the ink conglomerate-reducing tank 503 to the ink reservoir 115.

The third exemplary embodiment 501 may include a conglomerate-reducing device 117 similar to the conglomerate-reducing device 117 of the first and second exemplary embodiments 301, 401. The probe 303 of the conglomerate-reducing device 117 may be inserted into ink in the ink conglomerate-reducing tank 503. In this manner, the sonic energy created by the probe 303 may reduce and/or eliminate any conglomerates of ink in the ink conglomerate-reducing tank 503. Such conglomerates of ink may have formed (e.g., due to stagnation) while the ink was stored in the ink reservoir 115 and may have been transmitted from the ink reservoir 115 to the ink conglomerate-reducing tank 503 via the ink circulation supply line 505 or may have been formed while the ink was stored in the ink conglomerate-reducing tank 503. Consequently, the conglomerate-reducing device 117 may revitalize (e.g., reactivate) the ink in the ink conglomerate-reducing tank 503 by reducing any conglomerates of ink into particles and may transfer such revitalized ink to the ink reservoir 115 via the ink circulation drain line 507. Thereafter, such revitalized ink may be transferred from the ink reservoir 115 to the inkjet printing module 103 (e.g., the inkjet head of the inkjet printing module 103) via the ink supply line 107.

Although the ink delivery module 105 includes the conglomerate-reducing device 117, in some embodiments, one or more portions of the conglomerate-reducing device 117 (e.g., the power source 305) may be external to the ink delivery module 105. Further, although the conglomerate-reducing device 117 includes one probe 303 coupled to one power source 305, the conglomerate-reducing device 117 may include a larger number of probes 303 and/or power sources 305. Such additional probes 303 may be inserted into the ink conglomerate-reducing tank 503 and/or one or more other components of the third exemplary embodiment 501 such that sonic energy created by the probes 303 in such components reduce and/or eliminate any conglomerates of ink in the ink of such components.

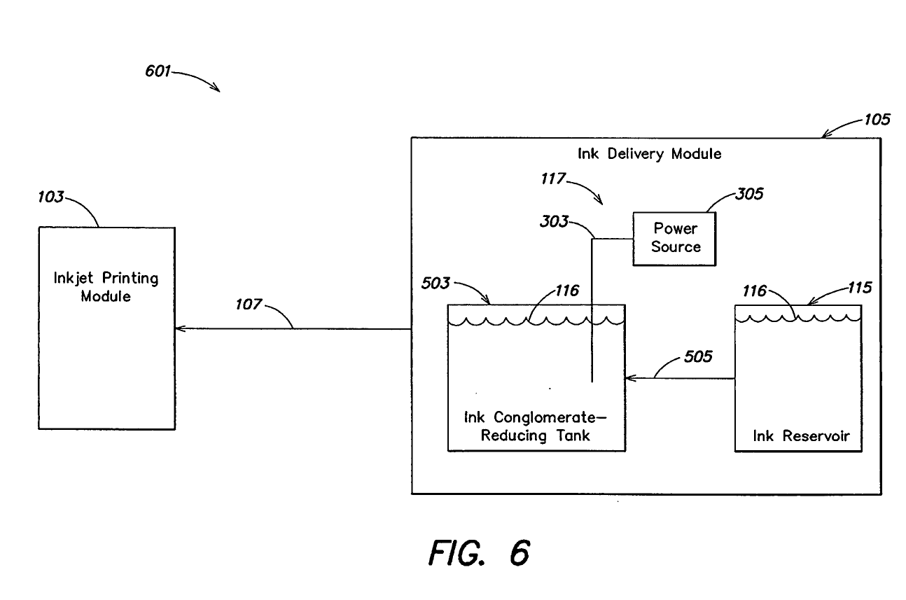

FIG. 6 is a block diagram of a fourth exemplary embodiment 601 of the apparatus of FIG. 1B in accordance with an embodiment of the present invention. The embodiment of FIG. 6 may be the same as that of FIG. 5, except for the fact that the ink conglomerate-reducing tank 503 is coupled downstream from the ink reservoir 115. Accordingly, the ink circulation drain line 507 may be omitted from the apparatus 601 of FIG. 6, and ink may be supplied directly from ink conglomerate-reducing tank 503 to the inkjet printing module 103. Like the embodiment of FIG. 5, the ink conglomerate-reducing tank 503 of FIG. 6 may be coupled to the ink reservoir 115 via a supply line 505 for transferring ink from the ink reservoir 115 to the ink conglomerate-reducing tank 503.

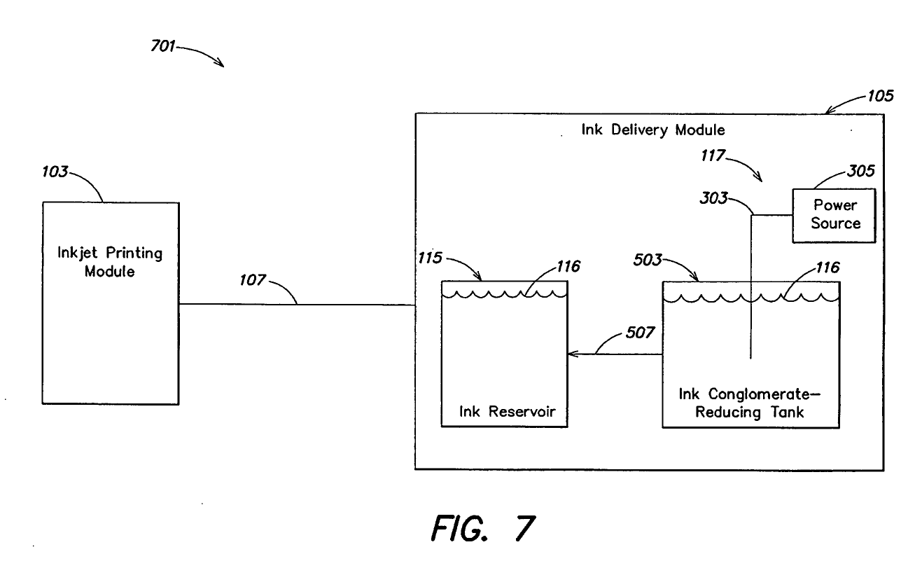

FIG. 7 is a block diagram of a fifth exemplary embodiment of the apparatus of FIG. 1B in accordance with an embodiment of the present invention. The fifth exemplary embodiment 701 of the apparatus for reducing an ink conglomerate during flat panel display manufacturing may be configured similar to the apparatus 501 of FIG. 5, except that the ink circulation drain line 505 is omitted, such that ink having been treated in the ink conglomerate-reducing tank 503 travels to the ink reservoir 115 where it may be temporarily stored prior to being transferred to the inkjet printing module 103 (e.g., the inkjet head of the inkjet printing module 103) via the ink supply line 107 to which the ink reservoir 115 may be coupled.

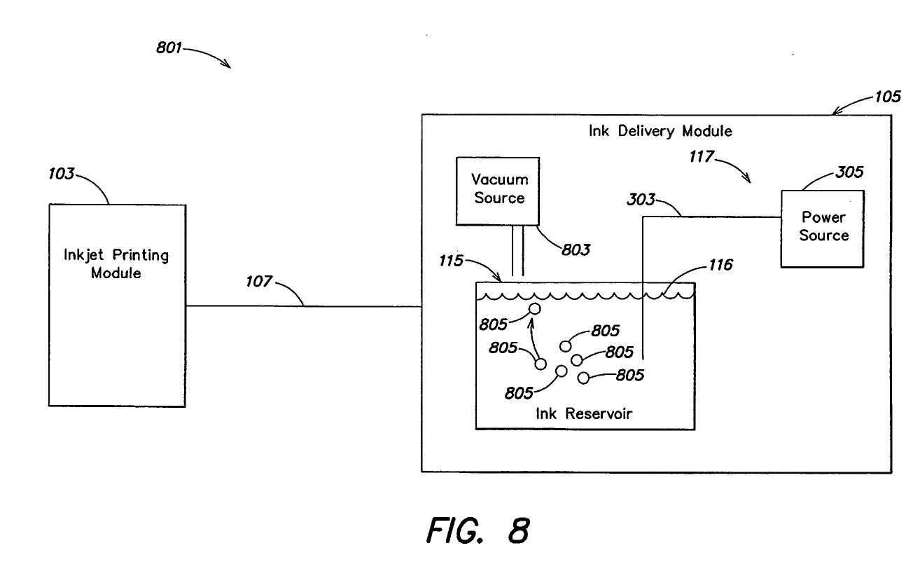

FIG. 8 is a block diagram of a sixth exemplary embodiment of the apparatus of FIG. 1B in accordance with an embodiment of the present invention. With reference to FIG. 8, the sixth embodiment 801 is similar to the first exemplary embodiment 301. However, the sixth embodiment 801 may include one or more vacuum sources 803 (only one shown) for providing a vacuum (e.g., a slightly negative pressure) to ink (e.g., adjacent the ink, such as above the ink) so as to remove air bubbles 805 that may have been created in the ink while breaking a conglomerate of ink into a plurality of particles. More specifically, cavitation caused by the conglomeration reducing sonic energy may create air bubbles in the ink (e.g., generate air bubbles in the ink by degassing air already dissolved in the ink). The vacuum introduced to the ink (e.g., adjacent the ink) by the one or more vacuum sources 803 may remove such air bubbles. In some embodiments, the vacuum source 803 may provide a sub-atmospheric pressure of about 600 Torr to the ink (although the vacuum source 803 may provide a larger or smaller sub-atmospheric pressure to the ink). In this manner, the sixth embodiment 801 may avoid adverse affects caused by air bubbles in the ink used during flat panel display manufacturing.

In the sixth embodiment 801, because the sonic probe 303 provides sonic energy to the ink 116 stored in the ink reservoir 115, the vacuum source 803 may provide a vacuum to the ink stored in the ink reservoir 115. However, additionally or alternatively, the vacuum source 803 may provide a vacuum to the ink in another portion of the sixth embodiment 801 of the apparatus (e.g., upstream or downstream from the ink reservoir 115). Further, although the vacuum source 803 is included in the ink delivery module 105, in some embodiments, one or more components of the vacuum source may be external to the ink delivery module 105.

In a similar manner, a vacuum source 803 or similar device for creating a negative pressure may be employed in the second through fifth exemplary embodiments 401-701 to remove air bubbles 805 created in the ink of such embodiments while breaking a conglomerate of ink in such ink into a plurality of ink particles (e.g., by employing a sonic probe 303 or the like).

### Non-Probe Transducers

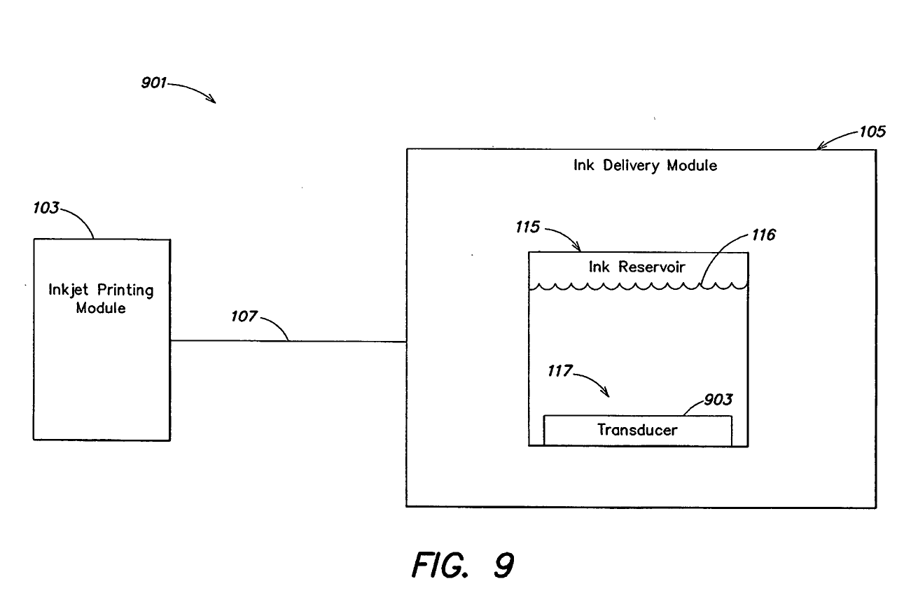

FIG. 9 is a block diagram of a seventh exemplary embodiment of the apparatus of FIG. 1B in accordance with an embodiment of the present invention. With reference to FIG. 9, the seventh exemplary embodiment 901 is similar to the first exemplary embodiment 301 of FIG. 3. However, in contrast to the first exemplary embodiment 301 in which the conglomerate-reducing device 117 is a sonic probe 303 coupled to a power source 305, the conglomerate-reducing device 117 of the seventh exemplary apparatus 901 includes a non-probe transducer 903 (e.g., a transducer mounted to one of the walls of the ink reservoir 115) adapted to create sonic energy, such as ultrasonic, megasonic, or similar energy. The transducer 903 may be operatively coupled to the ink 116. For example, the transducer 930 may be coupled to (e.g., inside or coupled to transmit energy through the walls of) the ink reservoir 115, and therefore, may create sonic energy in the ink stored by the ink reservoir 115. As described above, sonic energy provided to such ink may break a conglomerate of ink into a plurality of particles (e.g., particles which may not adversely affect flat panel display manufacturing). Although the ink delivery module 105 includes the conglomerate-reducing device 117, in some embodiments, one or more portions of the conglomerate-reducing device 117 may be external to the ink delivery module 105. Further, although the conglomerate-reducing device 117 includes one transducer 903, the conglomerate-reducing device 117 may include a larger number of transducers 903. Such additional transducers 903 may be coupled to (e.g., inserted into or coupled to transmit energy through the walls of) the ink reservoir 115 and/or one or more other components of the seventh exemplary embodiment 901 such that sonic energy created by the additional transducers 903 in such components reduce and/or eliminate any conglomerates of ink in such components.

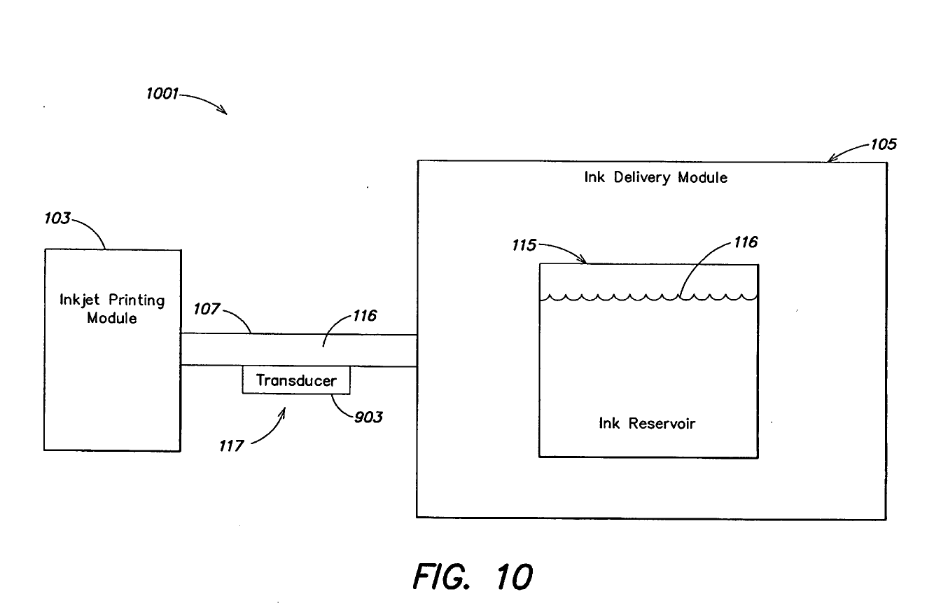

FIG. 10 is a block diagram of an eighth exemplary embodiment of the apparatus of FIG. 1B in accordance with an embodiment of the present invention. With reference to FIG. 10, the eighth exemplary embodiment 1001 is similar to the second exemplary embodiment 401 of FIG. 4. However, in contrast to the second exemplary embodiment 401 in which the conglomerate-reducing device 117 is a sonic probe 303 coupled to a power source 305, the conglomerate-reducing device 117 of the eighth exemplary apparatus 1001 for reducing an ink conglomerate during flat panel display manufacturing may include a non-probe transducer 903 for creating sonic energy. The transducer 903 of the eighth exemplary apparatus 1001 may be coupled to and/or inserted into the ink supply line 107, which couples the ink delivery module 105 to the inkjet printing module 103, and more specifically, couples the ink reservoir 115 to the inkjet head (not shown in FIG. 10; 109 in FIG. 1B). In this manner, the sonic energy created by the transducer 903 may reduce and/or eliminate any conglomerates of ink transmitted from the ink delivery module 105 into the ink supply line 107. Such conglomerates of ink may have formed (e.g., due to stagnation) while the ink was stored in the ink reservoir 115. Although the conglomerate-reducing device 117 includes one transducer 903, the conglomerate-reducing device 117 may include a greater number of transducers 903. Such additional transducers 903 may be coupled to (e.g., inserted into or coupled to transmit energy through the wall of) the ink supply line 107.

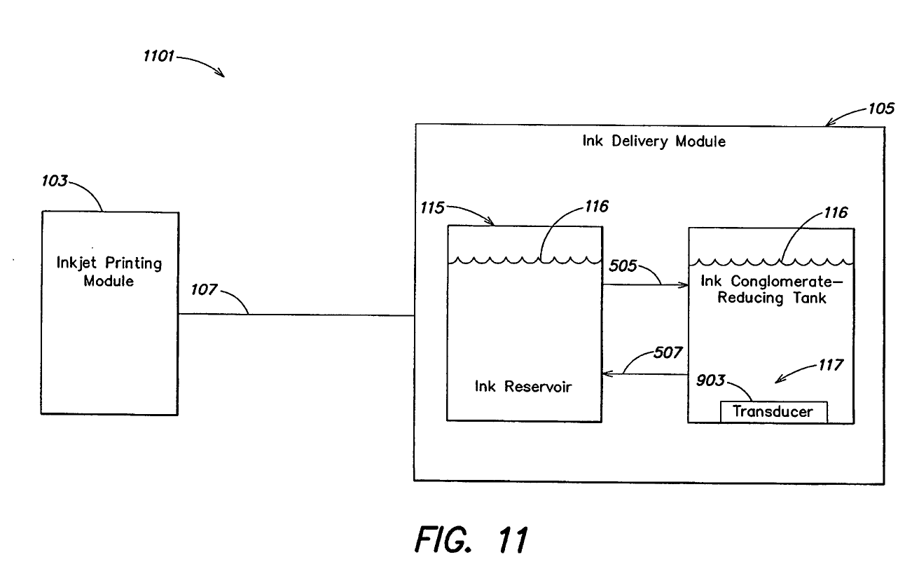

FIG. 11 is a block diagram of a ninth exemplary embodiment of the apparatus of FIG. 1B in accordance with an embodiment of the present invention. With reference to FIG. 11, the ninth exemplary embodiment 1101 is similar to the third exemplary embodiment 501 of FIG. 5. However, in contrast to the third exemplary embodiment 501 in which the conglomerate-reducing device 117 is a sonic probe 303 coupled to a power source 305, the conglomerate-reducing device 117 of the ninth exemplary apparatus 1101 for reducing an ink conglomerate during flat panel display manufacturing includes a non-probe transducer 903 as described with reference to FIG. 9.

Although the conglomerate-reducing device 117 shown includes one transducer 903, the conglomerate-reducing device 117 may include a larger number of transducers 903. Such additional transducers 903 may be coupled to (e.g., inserted into or coupled so as to transmit sonic energy through the walls of) the ink conglomerate-reducing tank 503.

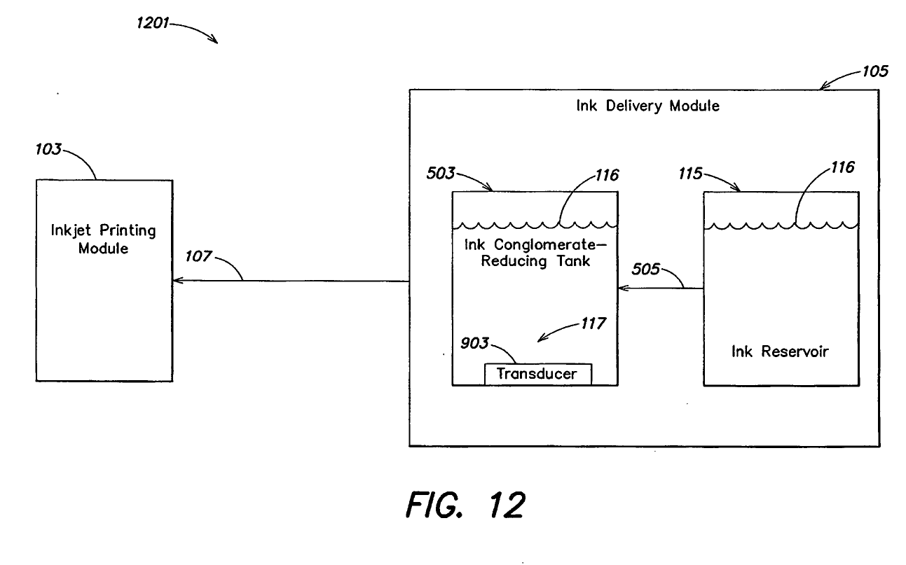

FIG. 12 is a block diagram of a tenth exemplary embodiment of the apparatus of FIG. 1B in accordance with an embodiment of the present invention. With reference to FIG. 12, the tenth exemplary embodiment 1201 is similar to the fourth exemplary embodiment 601 of FIG. 6. However, in contrast to the fourth exemplary embodiment 601 in which the conglomerate-reducing device 117 is a sonic probe 303 coupled to a power source 305, the conglomerate-reducing device 117 of the tenth exemplary apparatus 1201 for reducing an ink conglomerate during flat panel display manufacturing includes a non-probe transducer 903 as described with reference to FIG. 9.

Although the conglomerate-reducing device 117 includes one transducer 903, the conglomerate-reducing device 117 may include a larger number of transducers 903. Such additional transducers 903 may be coupled to (e.g., inserted into or coupled so as to transmit sonic energy through the wall of) the ink conglomerate-reducing tank 903.

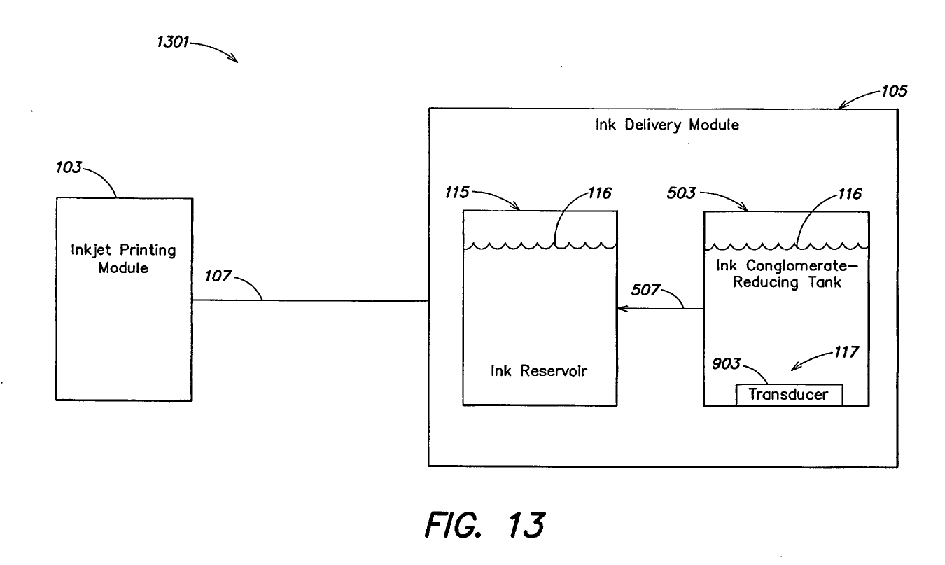

FIG. 13 is a block diagram of an eleventh exemplary embodiment of the apparatus of FIG. 1B in accordance with an embodiment of the present invention. With reference to FIG. 13, the eleventh exemplary embodiment 1301 is similar to the fifth exemplary embodiment 701 of FIG. 7. However, in contrast to the fifth exemplary embodiment 701 in which the conglomerate-reducing device 117 is a sonic probe 303 coupled to a power source 305, the conglomerate-reducing device 117 of the eleventh exemplary apparatus 1301 for reducing an ink conglomerate during flat panel display manufacturing includes a non-probe transducer 903 as described with reference to FIG. 9.

Although the conglomerate-reducing device 117 shown includes one transducer 903, the conglomerate-reducing device 117 may include a larger number of transducers 903. Such additional transducers 903 may be coupled to (e.g., inserted into or coupled so as to transmit sonic energy through the wall of) the ink conglomerate-reducing tank 503.

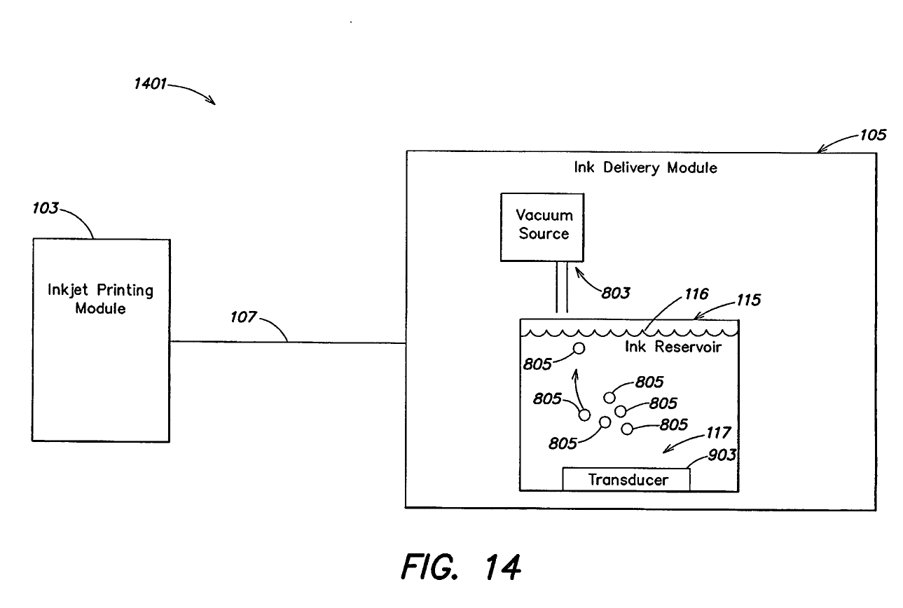

FIG. 14 is a block diagram of a twelfth exemplary embodiment of the apparatus of FIG. 1B in accordance with an embodiment of the present invention. With reference to FIG. 14, the twelfth embodiment 1401 is similar to the seventh exemplary embodiment 901. However, the twelfth exemplary embodiment 1401 may include one or more vacuum sources 803 (only one shown) for providing a vacuum (e.g., a slightly negative pressure) to the ink (e.g., adjacent the ink, such as above the ink) so as to remove air bubbles 805 created in the ink while breaking a conglomerate of ink into a plurality of ink particles. As stated previously, in some embodiments, the vacuum source 803 may provide a sub-atmospheric pressure of about 600 Torr to the ink (although the vacuum source 803 may provide a larger or smaller sub-atmospheric pressure to the ink).

In the twelfth embodiment 1401, because the transducer 903 provides sonic energy to the ink 116 stored in the ink reservoir 115, the vacuum source 803 may provide a vacuum to the ink stored in the ink reservoir 115. Although the vacuum source 803 may provide a vacuum to the ink in another portion of the twelfth embodiment 1401 of the apparatus (e.g., upstream or downstream from the ink reservoir 115). Further, although the vacuum source 803 is included in the ink delivery module 105, in some embodiments, one or more components of the vacuum source 803 may be external to the ink delivery module 105.

In a similar manner, a vacuum source 803 or similar device for creating a negative pressure may be employed in the eighth 1001 through eleventh exemplary embodiments 1301 to remove air bubbles 805 created in the ink of such embodiments.

### Exemplary Embodiments Employing Milling

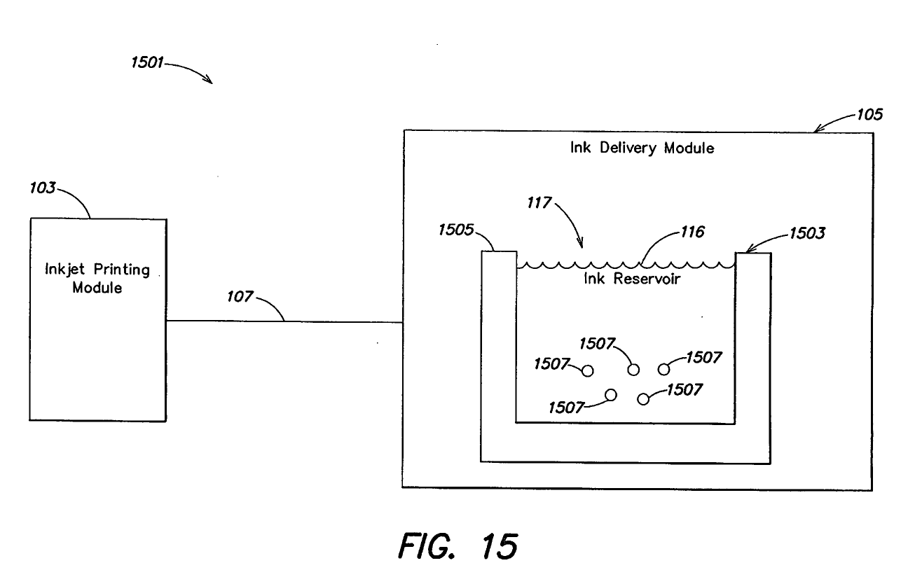

FIG. 15 is a block diagram of a thirteenth exemplary embodiment of the apparatus of FIG. 1B in accordance with an embodiment of the present invention. With reference to FIG. 15, the thirteen exemplary embodiment 1501 is similar to the first exemplary embodiment 301 of FIG. 3. However, in contrast to the first exemplary embodiment 301 in which the conglomerate-reducing device 117 is a device adapted to create sonic energy, the conglomerate-reducing device 117 of the thirteenth exemplary embodiment 1501 for reducing an ink conglomerate during flat panel display manufacturing may be a milling device 1503 (e.g., a continuous bead milling machine, such as a NETZSCH MiniZETA™ Series manufactured by NETZSCH Incorporated of Exton, Pa., or the like). For example, the milling device 1503 may include a milling chamber 1505, which may serve as an ink reservoir, and beads (e.g., ceramic beads) 1507 positioned within the milling chamber 1505. The milling device 1503 may be adapted to store ink 116 and the beads 1507, and to impart a centripetal force to the ink 116 and beads 1505. For example, the milling device 1503 may rotate the milling chamber 1505 so as to spin the ink 116 and the beads 1507. Therefore, during operation, the beads 1507 may collide with any conglomerates of ink and break (e.g., mill) such conglomerates into a plurality of particles (e.g., smaller particles which may not adversely affect flat panel display manufacturing). In this manner, any conglomerates of ink may be reduced and/or eliminated from the ink which is transmitted from the ink reservoir to the ink supply line 107. In one embodiment, the radius of the one or more beads 1507 may be approximately 0.05 mm to 5 mm. However, one or more of the beads 1507 may be of a larger or smaller size. For example, for inks including a smaller pigment particle size, small beads (e.g., beads <1 mm in radius) may be employed. Further, one or more of the beads 1507 may be of a different shape and/or a plurality of different shapes and/or sizes. Additionally, although the conglomerate-reducing device 117 includes one milling device 1503, the conglomerate-reducing device 117 may include a larger number of milling devices 1503. Note that although the milling chamber 1505 is depicted in FIG. 15 as an open chamber, in some embodiments it may be sealed.

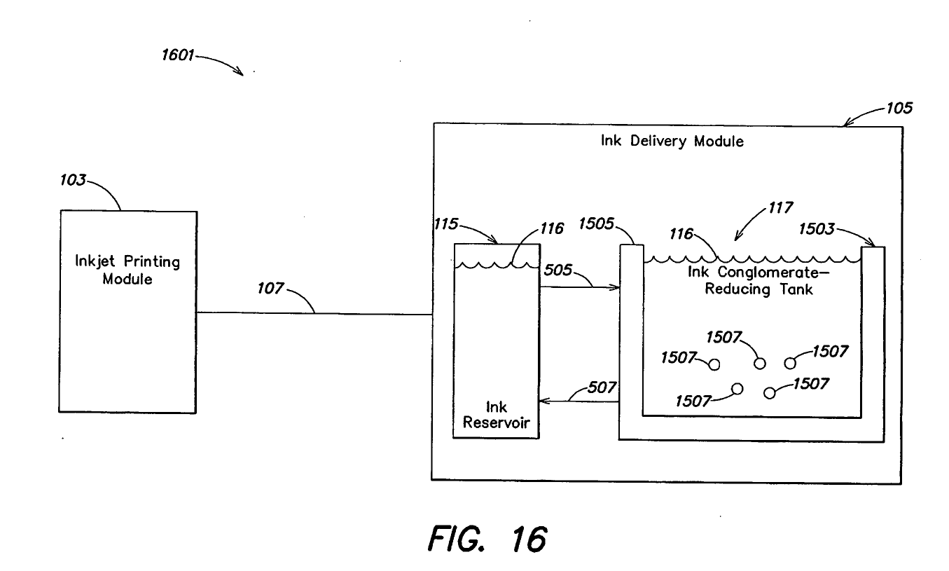

FIG. 16 is a block diagram of a fourteenth exemplary embodiment of the apparatus of FIG. 1B in accordance with an embodiment of the present invention. With reference to FIG. 16, the fourteenth exemplary embodiment 1601 is similar to the third exemplary embodiment 501 of FIG. 5. However, in contrast to the third exemplary embodiment 501 in which the conglomerate-reducing device 117 is a device adapted to create sonic energy, the conglomerate-reducing device 117 of the fourteenth exemplary apparatus 1601 for reducing an ink conglomerate during flat panel display manufacturing includes a milling device 1503 similar to the milling device 1503 of the thirteen exemplary embodiment 1501 shown in FIG. 15. The fourteenth exemplary embodiment 1601 of the apparatus for reducing an ink conglomerate during flat panel display manufacturing may include a milling device 1503, the milling chamber 1505 of which may serve as a ink conglomerate-reducing tank, coupled to the ink reservoir 115. More specifically, the ink conglomerate-reducing tank may be coupled the ink reservoir 115 via an ink circulation supply line 505 for transferring ink from the ink reservoir 115 to the ink conglomerate-reducing tank. Further, the ink conglomerate-reducing tank may be coupled to the ink reservoir 115 via an ink circulation drain line 507 for transferring ink from the ink conglomerate-reducing tank to the ink reservoir 115.

Although the ink conglomerate-reducing tank is positioned upstream from the ink reservoir 115, the ink conglomerate-reducing tank may be positioned differently (e.g., downstream from the ink reservoir 115).

In the manner described above, the milling device 1503 may reduce and/or eliminate any conglomerates of ink in the milling chamber 1505, which serves as the ink conglomerate-reducing tank. Consequently, the conglomerate-reducing device 117 (e.g., milling device 1503) may revitalize the ink in the ink conglomerate-reducing tank by breaking any conglomerates on ink into a plurality of particles and may transfer such revitalized ink to the ink reservoir 115 via the ink circulation drain line 507. Thereafter, such revitalized ink may be transferred from the ink reservoir 115 to the inkjet printing module 103 (e.g., the inkjet head of the inkjet printing module 103) via the ink supply line 107. Further, although the conglomerate-reducing device 117 includes one milling device 1503, the conglomerate-reducing device 117 may include a larger number of milling devices 1503. Note that although the milling chamber 1505 is depicted in FIG. 16 as an open chamber, in some embodiments it may be sealed.

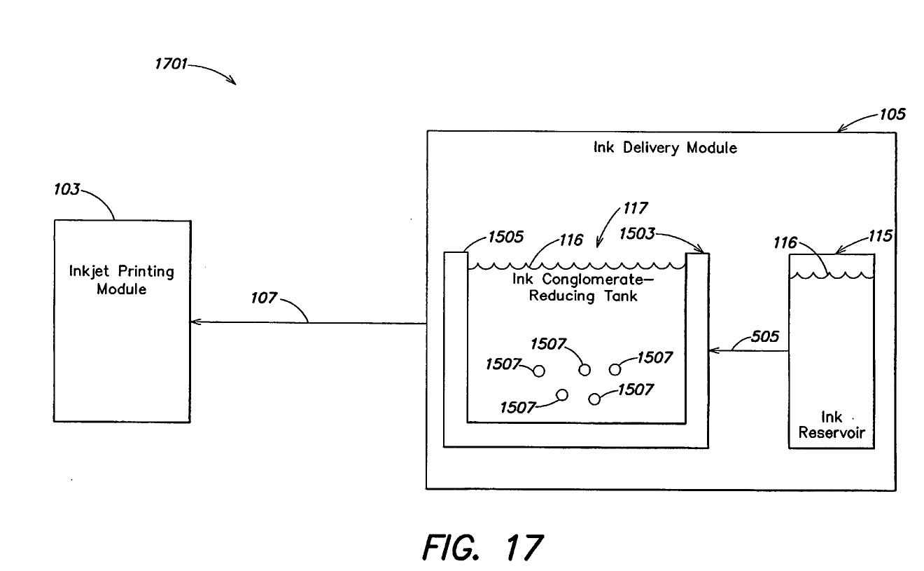

FIG. 17 is a block diagram of a fifteenth exemplary embodiment of the apparatus of FIG. 1B in accordance with an embodiment of the present invention. With reference to FIG. 17, the fifteenth exemplary embodiment 1701 is similar to the fourth exemplary embodiment 601 of FIG. 6. However, in contrast to the fourth exemplary embodiment 601 in which the conglomerate-reducing device 117 is a device for creating sonic energy, the conglomerate-reducing device 117 of the fifteenth exemplary apparatus 1701 for reducing an ink conglomerate during flat panel display manufacturing includes a milling device 1503 similar to the that of the thirteenth 1501 and fourteenth embodiments 1601. For example, a milling chamber 1505 of the milling device 1503 included in the fifteenth exemplary embodiment 1501 may serve as an ink conglomerate-reducing tank which is coupled to the inkjet printing module 103 via the ink supply line 107 and is coupled to the ink reservoir 115 via the ink supply line 505. Although the conglomerate-reducing device 117 includes one milling device 1503, the conglomerate-reducing device 117 may include a larger number of milling devices 1503. Note that although the milling chamber 1505 is depicted in FIG. 17 as an open chamber, in some embodiments it may be sealed.

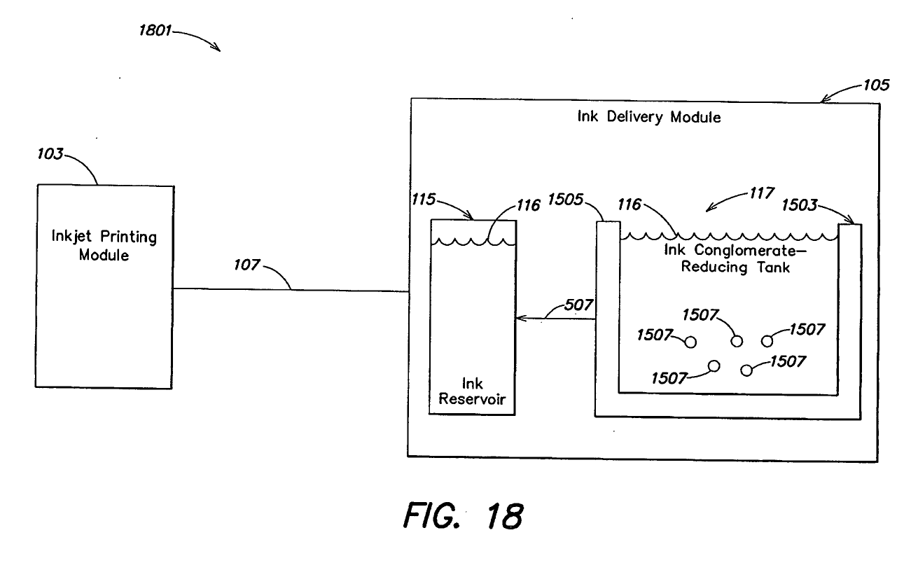

FIG. 18 is a block diagram of a sixteenth exemplary embodiment of the apparatus of FIG. 1B in accordance with an embodiment of the present invention. With reference to FIG. 18, the sixteenth exemplary embodiment 1801 is similar to the fifth exemplary embodiment 701 of FIG. 7. However, in contrast to the fifth exemplary embodiment 701 in which the conglomerate-reducing device 117 is a device for creating sonic energy, the conglomerate-reducing device 117 of the sixteenth exemplary apparatus 1801 for reducing an ink conglomerate during flat panel display manufacturing includes a milling device 1503 similar to the that of the thirteenth 1501 through fifteenth embodiments 1701. A milling chamber 1505 of the milling device 1503 included in the sixteenth exemplary embodiment 1501 may serve as an ink conglomerate-reducing tank which is coupled to the ink reservoir 115. More specifically, the ink conglomerate-reducing tank may be coupled to the ink reservoir 115 via an ink circulation drain line 507 for transferring ink from the ink conglomerate-reducing tank to the ink reservoir 115.

In the manner described above, the milling device 1503 may reduce and/or eliminate any conglomerates of ink in the ink conglomerate-reducing tank. Although the conglomerate-reducing device 117 includes one milling device 1503, the conglomerate-reducing device 117 may include a larger number of milling devices 1503. Note that although the milling chamber 1505 is depicted in FIG. 18 as an open chamber, in some embodiments it may be sealed.

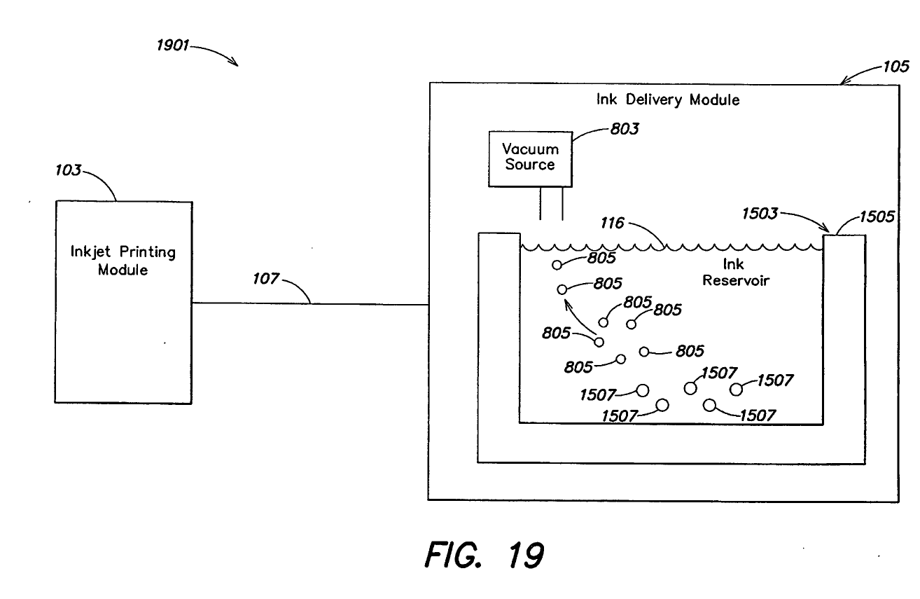

FIG. 19 is a block diagram of a seventeenth exemplary embodiment of the apparatus of FIG. 1B in accordance with an embodiment of the present invention. With reference to FIG. 19, the seventeenth embodiment 1901 is similar to the thirteenth exemplary embodiment 1501. However, the seventeenth exemplary embodiment 1901 may include one or more vacuum sources 803 (only one shown) for providing a vacuum (e.g., a slightly negative pressure) to ink (e.g., adjacent the ink, such as above the ink) so as to remove air bubbles 805 created in the ink while breaking a conglomerate of ink into a plurality of ink particles. More specifically, while the ink is milled to reduce and/or eliminate a conglomerate of ink, air bubbles may be created in the ink (e.g., as milling may generate air bubbles by degassing air already dissolved in the ink). The vacuum introduced to (e.g., provided adjacent to) the ink by the one or more vacuum sources 803 may remove such air bubbles. As stated, in some embodiments, the vacuum source 803 may provide a sub-atmospheric pressure of 600 Torr to the ink (although the vacuum source 803 may provide a larger or smaller sub-atmospheric pressure to the ink). Note that although the milling chamber 1505 is depicted in FIG. 19 as an open chamber, in some embodiments it may be sealed to better maintain the sub-atmospheric vacuum pressure.

In the seventeenth embodiment 1901, because the milling chamber 1505 of the milling device 1503 may serve as a reservoir for ink, the vacuum source 803 may provide a vacuum to (e.g., adjacent to) the ink in such reservoir. However, the vacuum source 803 may provide a vacuum to the ink in another portion of the seventeenth embodiment 1901 of the apparatus (e.g., upstream or downstream from the ink reservoir). Further, although the vacuum source 803 is included in the ink delivery module 105, in some embodiments, one or more components of the vacuum source may be external to the ink delivery module 105.

In a similar manner, a vacuum source 803 or similar device for creating a negative pressure may be employed in the fourteenth through sixteenth exemplary embodiments 1601-1801 to remove air bubbles 805 created in the ink of such embodiments.

As described above, the present methods and apparatus may provide a particle (e.g., conglomerate) breakdown system that may be coupled directly or indirectly to an ink delivery line of an apparatus for flat panel display manufacturing. The particle breakdown system may be part of an ink reservoir or may be coupled between the ink reservoir and an inkjet head of the apparatus. Alternatively, the particle breakdown system may be implemented offline (e.g., upstream from the ink reservoir) so long as the particle breakdown system may revitalize ink before the ink is used for flat panel display manufacturing.

The foregoing description discloses only exemplary embodiments of the invention. Modifications of the above disclosed apparatus and methods which fall within the scope of the invention will be readily apparent to those of ordinary skill in the art. For instance, in embodiments of the invention that employ sonic energy to reduce an ink conglomerate during flat panel display manufacturing, sonic energy of about 20 kHz may be employed. However, a larger or smaller frequency of sonic energy may be employed.

The present method of reducing an ink conglomerate may be employed shortly before ink is to be transmitted to the inkjet printing module 103 or for a longer period of time, for example, during (e.g., intermittently or throughout) flat panel display manufacturing. Further, the present methods and apparatus may be used for a variety of inks, such as an ultraviolet-curable (UV-curable) ink, electron-beam-curable (e-Beam-curable) ink or the like. Although the present methods and apparatus are described with reference to an apparatus for dispensing ink with an inkjet head, the present methods and apparatus may be employed by other systems or apparatus for dispensing ink. Some exemplary embodiments of the present apparatus for reducing a conglomerate of ink may include any combination of a sonic probe or the like, a non-probe transducer or the like and a milling device or the like.

Accordingly, while the present invention has been disclosed in connection with exemplary embodiments thereof, it should be understood that other embodiments may fall within the spirit and scope of the invention, as defined by the following claims.

The invention claimed is:

1. An apparatus for reducing an ink conglomerate during flat panel display manufacturing, comprising:
an inkjet head adapted to dispense ink onto a substrate during inkjet printing;
an ink reservoir adapted to store ink for inkjet printing and supply the ink to the inkjet head; and
a conglomerate-reducing device adapted to break apart conglomerates in the ink before the ink reaches the inkjet head.

2. The apparatus of claim 1 wherein the conglomerate-reducing device is adapted to break apart conglomerates in the ink while the ink is in the ink reservoir.

3. The apparatus of claim 2 further comprising a vacuum source adapted to provide a vacuum to the ink reservoir such that air bubbles created in the ink of the ink reservoir by the conglomerate-reducing device are removed.

4. The apparatus of claim 1 wherein the conglomerate-reducing device includes a transducer, coupled to a sonic power source, and adapted to employ sonic energy to break apart conglomerates in the ink.

5. The apparatus of claim 4 wherein the transducer is inserted into or coupled to the ink reservoir.

6. The apparatus of claim 4 wherein the transducer is further adapted to employ at least one of ultrasonic and megasonic energy to break apart conglomerates in the ink.

7. The apparatus of claim 4 further comprising an ink supply line coupling the inkjet head to the ink reservoir;
wherein the transducer is inserted in or coupled to the ink supply line.

8. The apparatus of claim 4 further comprising an ink conglomerate-reducing tank coupled to the ink reservoir;
wherein:
the transducer is inserted into or coupled to the ink conglomerate-reducing tank; and
the ink conglomerate-reducing tank is adapted to:
employ the transducer to break apart conglomerates in ink stored by the ink conglomerate-reducing tank, thereby forming revitalized ink; and
transfer the revitalized ink to the ink reservoir or the inkjet head.

9. The apparatus of claim 8 further comprising a vacuum source adapted to provide a vacuum to the ink conglomerate-reducing tank such that air bubbles created by the transducer in the ink of the ink conglomerate-reducing tank are removed.

10. The apparatus of claim 4 wherein the transducer comprises a sonic probe.

11. The apparatus of claim 1 wherein the conglomerate-reducing device comprises a milling device.

12. The apparatus of claim 11 wherein the milling device forms part of the ink reservoir.

13. The apparatus of claim 12 further comprising a vacuum source adapted to provide a vacuum to the ink reservoir such that air bubbles created in the ink of the ink reservoir during milling are removed.

14. The apparatus of claim 1 further comprising:
an ink conglomerate-reducing tank coupled to the ink reservoir;
wherein the ink conglomerate-reducing tank includes a milling device adapted to break apart conglomerates in the ink.

15. The apparatus of claim 14 wherein the ink conglomerate-reducing tank is further adapted to:
employ milling to break apart conglomerates in ink stored by the ink conglomerate-reducing tank, thereby forming revitalized ink; and
transfer the revitalized ink to the ink reservoir or the inkjet head.

16. The apparatus of claim 15 further comprising a vacuum source adapted to provide a vacuum to the ink conglomerate-reducing tank such that air bubbles created in the ink of the ink conglomerate-reducing tank during milling are removed.

17. A method of reducing conglomerates in ink during flat panel display manufacturing, comprising:
transferring the ink from an ink reservoir to an inkjet head; and
breaking apart conglomerates in the ink before the ink reaches the inkjet head.

18. The method of claim 17 wherein breaking apart conglomerates in the ink is performed in the ink reservoir.

19. The method of claim 18 further comprising providing a vacuum to the ink reservoir such that air bubbles created in the ink of the ink reservoir while breaking apart conglomerates in the ink are removed.

20. The method of claim 17 wherein breaking apart conglomerates in ink includes employing sonic energy to break apart conglomerates in the ink.

21. The method of claim 17 wherein:
transferring the ink from the ink reservoir to the inkjet head includes transferring the ink from the ink reservoir to the inkjet head via an ink supply line; and
breaking apart conglomerates in ink includes employing sonic energy in the ink supply line to break apart conglomerates in the ink.

22. The method of claim 17 wherein:
transferring the ink from the ink reservoir to the inkjet head includes transferring ink from the ink reservoir to an ink conglomerate-reducing tank; and
breaking apart conglomerates in ink includes employing sonic energy in the ink conglomerate-reducing tank to break apart conglomerates in the ink.

23. The method of claim 22 further comprising providing a vacuum to the ink conglomerate-reducing tank such that air bubbles created in the ink of the ink conglomerate-reducing tank while breaking apart conglomerates in ink are removed.

24. The method of claim 22 further comprising transferring the ink from the ink conglomerate-reducing tank back to the ink reservoir or to the inkjet head.

25. The method of claim 17 wherein breaking apart conglomerates in ink includes employing milling to break apart conglomerates in the ink.

26. The method of claim 25 further comprising employing a vacuum to remove air bubbles created in the ink during milling.
